(19) United States
(12) Patent Application Publication
(10) Pub. No.: US 2014/0354188 A1
(43) Pub. Date: Dec. 4, 2014

(54) Remote Monitoring Systems

(71) Applicant: Toshiba Lighting & Technology Corporation, Yokosuka-shi (JP)

(72) Inventors: Junko Takahashi, Yokosuka-shi (JP); Hidenori Nishigaki, Yokosuka-shi (JP); Sayaka Kikuta, Yokosuka-shi (JP); Takashi Shimizu, Yokosuka-shi (JP); Kenji Takahashi, Yokosuka-shi (JP); Taichi Mori, Yokosuka-shi (JP)

(73) Assignee: TOSHIBA LIGHTING & TECHNOLOGY CORPORATION, Yokosuka-shi (JP)

(21) Appl. No.: 14/143,026

(22) Filed: Dec. 30, 2013

(30) Foreign Application Priority Data
May 31, 2013 (JP) 2013-115562

(51) Int. Cl. H05B 37/00

(52) U.S. Cl. CPC H05B 37/00
USPC 315/312

(57) ABSTRACT

According to one embodiment, a remote monitoring system includes a remote apparatus to be remotely controlled according to a specified control signal, and a remote control apparatus to communicate with the remote apparatus by specified communication and to remotely control the remote apparatus, in which the remote apparatus includes a holding part to hold location information of a location where the remote apparatus is installed, a detection part to detect specified information, and a communication part which associates the specified information detected by the detection part with the location information held by the holding part and transmits the associated information to the remote control apparatus.

### CROSS-REFERENCE TO RELATED APPLICATION

This application is based upon and claims the benefit of priority from the prior Japanese Patent Application No. 2013-115562 filed on May 31, 2013; the entire contents of which are incorporated herein by reference.

### FIELD

Embodiments described herein relate generally to a remote monitoring system.

### BACKGROUND

Hitherto, street lights respectively managed by a management body, such as a city, town, village, community association or store's association, are dotted in a specified area, and the management body keeps placement locations of the respective street lights recorded on a sheet indicating the area. The placement of the street lights is performed also by a power company to supply power. In the management of the street lights as stated above, the acquisition of information of the placement of the street lights and the operation of recording the acquired information of the placement of the street lights on a map are manually performed. Thus, as the number of the street lights increases, much labor is required.

Thus, a street light management apparatus is used which reads out identification information and location information of plural street lights located in a specified management area from a database in which identification information and location information of street lights are associated and stored, and creates a management map on which the street lights are placed. By using the street light management apparatus as stated above, the registration for managing the placement state of the street lights and the creation of the management map are easily performed, and the efficiency of the management of the street lights is improved.

### BRIEF DESCRIPTION OF THE DRAWINGS

FIG. 1 is a view showing a structure of a remote monitoring system of a first embodiment.

FIG. 2 is a view showing a structure of a remote monitoring system of a modification example of the first embodiment.

FIG. 3 is a view showing a structure of a remote monitoring system of a second embodiment.

FIG. 4 a view showing a structure of a remote monitoring system of a third embodiment.

### DETAILED DESCRIPTION

In general, according to one embodiment, a remote monitoring system includes a remote apparatus to be remotely controlled according to a specified control signal, and a remote control apparatus to communicate with the remote apparatus by specified communication and to remotely control the remote apparatus, and the remote apparatus includes a holding part to hold location information of a location where the remote apparatus is installed, a detection part to detect specified information, and a communication part which associates the specified information detected by the detection part with the location information held by the holding part and transmits the associated information to the remote control apparatus.

Besides, in the remote monitoring system, the remote control apparatus maps the specified information according to the location information.

Besides, in the remote monitoring system, the remote control apparatus transmits the mapped information to an external server.

Besides, in the remote monitoring system, the remote apparatus includes an acquisition part to automatically acquire the location information of the location where the remote apparatus itself is installed, and the communication part associates the specified information with the location information acquired by the acquisition part and transmits the associated information to the remote control apparatus.

Besides, in the remote monitoring system, the remote apparatus further includes an interface to communicate with a portable terminal by specified communication, and when the interface communicates with the portable terminal by the specified commucation, the communication part associates a notification state with the location information held by the holding part and transmits the associated notification sate to the remote control apparatus.

Besides, in the remote monitoring system, when the notification state is transmitted, the remote control apparatus notifies the location information associated with the notification state to a specified notification destination.

Besides, in the remote monitoring system, the remote control apparatus maps the notification state according to the location information.

Besides, in the remote monitoring system, the remote control apparatus transmits the mapped notification state to an external server.

Besides, in the remote monitoring system, the detection part includes at least one of a temperature sensor, a humidity sensor and a weather sensor.

Hereinafter, embodiments of the invention will be described in detail with reference to the drawings.

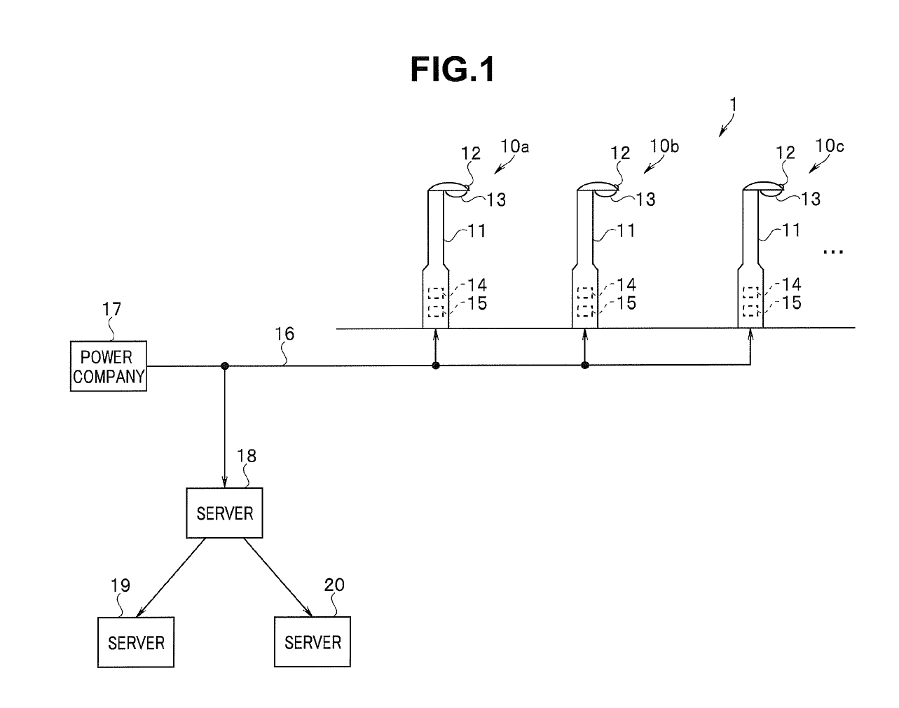

First, a structure of a remote monitoring system of a first embodiment will be described with reference to FIG. 1. FIG. 1 is a view showing the structure of the remote monitoring system of the first embodiment.

As shown in FIG. 1, a remote monitoring system 1 includes plural street lights 10a, 10b, 10c, . . . to illuminate a road, a building, a park or the like. Incidentally, in the following description, all of or one of the street lights 10a, 10b, 10c, . . . is designated as the street light 10.

The street light 10 includes a pole 11 whose root portion is buried in, for example, the ground. A top of the pole 11 is provided with a sensor 12 and a light-emitting part 13, such as an LED, to emit light.

The sensor 12 constituting a detection part is, for example, a temperature sensor to detect temperature, a humidity sensor to detect humidity, or a weather sensor to detect weather. Incidentally, the sensor 12 is not limited to the temperature sensor, the humidity sensor and the weather sensor, but may be another sensor. Besides, although the street light 10 includes the one sensor 12, the street light may include all of the temperature sensor, the humidity sensor and the weather sensor.

The pole 11 of the street light 10 is provided with an identification ID 14 to identify the street light 10, and a communication part 15. The identification ID 14 constituting a holding part holds location information of the street light 10. The location information is, for example, an address where the street light 10 is installed. Corresponding location information is set in the identification ID 14 according to the location where the street light 10 is installed. That is, the identification ID 14 of the street light 10a holds the location information of the street light 10a, the identification ID 14 of the street light 10b holds the location information of the street light 10b, and the identification ID 14 of the street light 10c holds the location information of the street light 10c.

Besides, the street light 10 is connected with a power line 16, and power is supplied from a power company 17 through the power line 16. Further, the street light 10 is connected to a server 18 through the power line 16. The server 18 is a server of a management company to perform lighting control and management of the street light 10. That is, the street light 10 constitutes a remote apparatus to be remotely controlled according to a control signal from the server 18. Besides, the server 18 constitutes a remote control apparatus to communicate with the street light 10 by specified communication and to remotely control the street light 10.

In this embodiment, communication between the street light 10 and the power company 17 or between the street light 10 and the server 18 is performed by using PLC (power line communication) which uses the power line 16 as a communication line. That is, the communication part 15 of the street light 10 can perform data communication with the power company 17 and the server 18 through the power line 16 by using the PLC. Incidentally, the communication method is not limited to the PLC, and wireless communication or wired communication using another cable may be used.

Sensor information from the sensor 12 is inputted to the communication part 15. The communication part 15 associates the sensor information from the sensor 12 with the location information of the identification ID 14, and transmits to the server 18 through the power line 16.

The server 18 is a server to manage the street lights 10a, 10b, 10c, . . . , and receives the sensor information transmitted from the street lights 10a, 10b, 10c, . . . . As stated above, the sensor information is associated with the location information of the street lights 10a, 10b, 10c, . . . . The server 18 maps the received sensor information based on the associated location information. By this, a map can be obtained by which the distribution of temperature information, humidity information or weather information, which is transmitted as the sensor information, is known.

Besides, the server 18 can transmit the information (map information) in which the sensor information is mapped to an external server 19 or 20 according to a request from an external company. For example, when the external company including the server 19 requests the information in which the temperature information is mapped, the information in which the temperature information is mapped is transmitted to the server 19 of the external company. Besides, when another external company including the server 20 requests the information in which the humidity information is mapped, the information in which the humidity information is mapped is transmitted to the server 20 of the external company.

Further, the server 18 can disclose the information in which the sensor information is mapped to general users. By this, the user confirms the information in which the sensor information is mapped, and can recognize the temperature, humidity, weather and the like in an area.

As described above, the remote monitoring system 1 associates the sensor information detected by the sensor 12 with the location information held according to the location where the street light 10 is installed, and transmits to the server 18. The server 18 maps the transmitted sensor information according to the associated location information. The information in which the sensor information is mapped is transmitted to the external server 19 or 20, or is disclosed to general users. As a result, the information from the sensor 12 installed on the street light 10 can be utilized.

Thus, according to the remote monitoring system of this embodiment, the information from the many installed street lights can be efficiently managed.

### Modification Example

Next, a modification example of the first embodiment will be described.

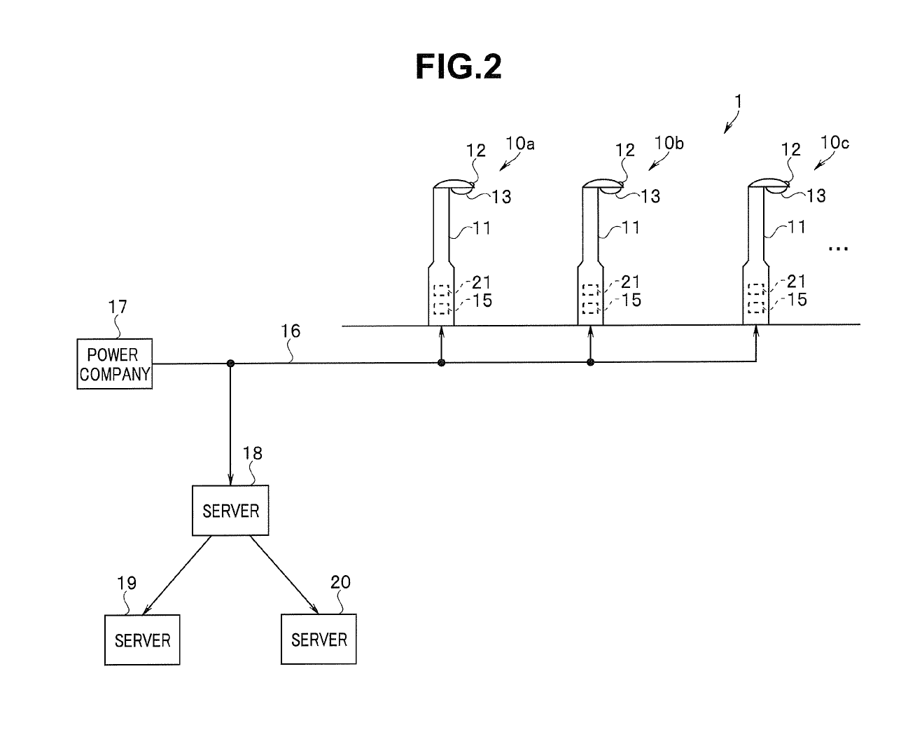

FIG. 2 is a view showing a structure of a remote monitoring system of the modification example of the first embodiment. Incidentally, in FIG. 2, the same components as those of FIG. 1 are denoted by the same reference numerals and their description is omitted.

As shown in FIG. 2, a street light 10 of the modification example is provided with a GPS receiving part 21 instead of the identification ID 14 of the first embodiment. The GPS receiving part 21 receives an electric wave from a GPS satellite, and measures the present location. By this, the location information where the street light 10 is installed can be obtained. As stated above, the GPS receiving part 21 constitutes an acquisition part to acquire the location information where the street light 10 is installed.

A communication part 15 associates sensor information with the location information measured by the GPS receiving part 21 and transmits to a server 18. At this time, since the street lights 10 are respectively arranged at different locations, the pieces of location information measured by the GPS receiving part 21 do not overlap with each other. Then, the location information itself can be used as address information used in communication. For example, the street light 10 is installed at a location of 35°00′00″ north latitude and 135°00′00″ east longitude, a combination of six numerals 35,00,00,135,00,00 is used as the address information. Besides, location information other than the GPS, which is digitized or symbolized, may be used as the address of communication. In this embodiment and other embodiments, a method of using the location information itself as the address of communication can be applied. The other configuration is the same as the first embodiment.

As described above, according to the remote monitoring system 1 of the first embodiment, the identification ID 14 as the location information is individually required to be registered according to the location where the street light 10 is installed. However, according to the remote monitoring system 1 of the modification example, the location information is not required to be registered according to the installed location.

### Second Embodiment

Next, a second embodiment will be described.

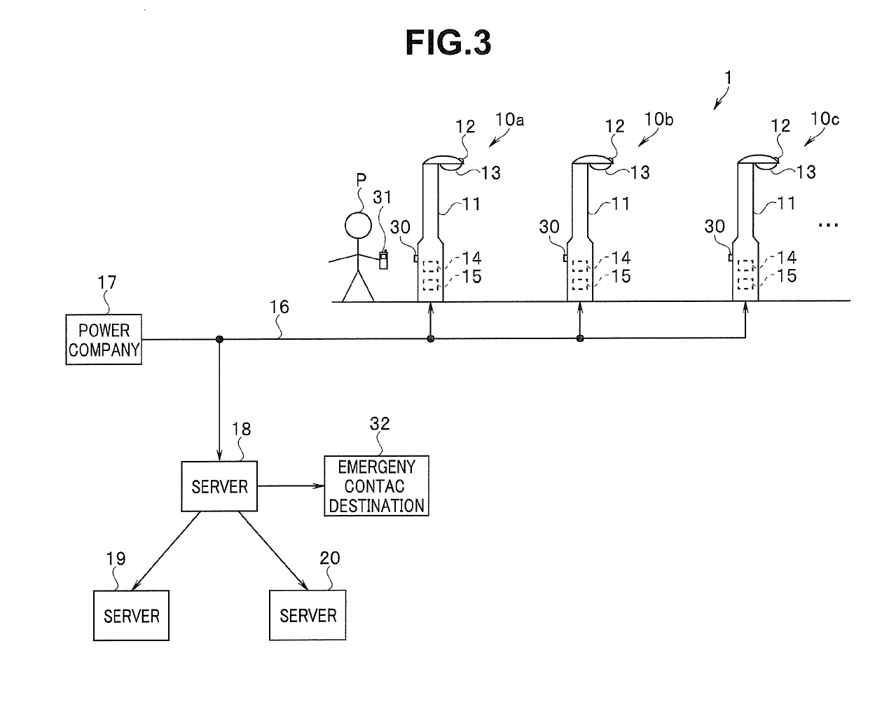

FIG. 3 is a view showing a structure of a remote monitoring system of the second embodiment. Incidentally, in FIG. 3, the same components as those of FIG. 1 are denoted by the same reference numerals and their description is omitted.

As shown in FIG. 3, a street light 10 is provided with an interface 30 capable of performing near distance communication such as NFC (near field communication). When a user P, for example, wants to make an emergency contact at the time of an emergency such as an incident or an accident, but does not know an accurate address or the like, the user sets a portable terminal 31 into a communicable state and holds it up to the interface 30.

When the interface 30 communicates with the portable terminal 31, a communication part 15 recognizes notification of emergency contact, associates the notification request of the emergency contact with location information of an identification ID 14, and transmits to a server 18 through a power line 16. When receiving the notification request of the emergency contact, the server 18 automatically notifies the emergency contact and the location information to a specified contact destination, for example, an emergency contact destination 32.

Besides, when the notification to the emergency contact destination 32 is performed, the server 18 uses the power line 16 to change the lighting state of a light-emitting part 13 of the street light 10 where the notification of the emergency contact is performed, and can notify the user that the notification to the emergency contact destination 32 is completed. Further, the server 18 changes the lighting states of adjacent street lights 10 in addition to the street light 10 where the notification of the emergency contact is performed, and can also notify other pedestrians and the like that an emergency situation occurs. That is, when the notification of the emergency contact is performed from the street light 10b, the lighting states of the street lights 10a and 10c installed in the vicinity thereof are also changed in addition to the street light 10b.

Besides, the server 18 manages the history of notification state of emergency contact, and maps the notification history information on a map. The server 18 can transmit the mapped notification history information to a server 19 or 20, or can disclose the information to general users. The user refers to the mapped notification history information together with a map screen or the like, and can also confirm the safety situation in the vicinity (for example, how often the emergency contact is made from which location).

Incidentally, in this embodiment, although the notification of the emergency contact is performed through the street light 10 and the server 18, no limitation is made to this. For example, when the portable terminal 31 communicates with the interface 30, the location information of the identification ID 14 is transmitted to the portable terminal 31, and the portable terminal 31 may automatically make emergency contact with the emergency contact destination 32.

Besides, the interface 30 may be, for example, a two-dimensional barcode such as a QR code (registered trademark). The location information of the street light 10 is registered in the two-dimensional barcode, the portable terminal 31 reads the location information of the street light 10 from the two-dimensional barcode, and the portable terminal 31 automatically makes emergency contact with the emergency contact destination 32.

As described above, according to the remote monitoring system of the second embodiment, even if the user does not know accurate location information at the time of emergency such as an accident or an incident, the accurate location information can be notified to the emergency contact destination 32.

### Third Embodiment

Next, a third embodiment will be described.

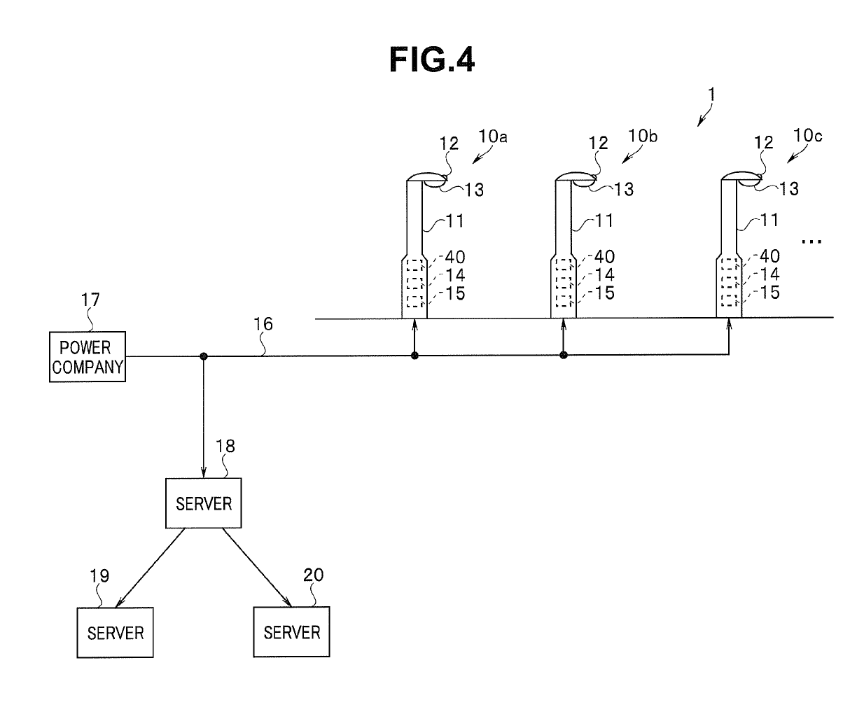

FIG. 4 is a view showing a structure of a remote monitoring system of the third embodiment. Incidentally, in FIG. 4, the same components as those of FIG. 1 are denoted by the same reference numerals and their description is omitted.

A street light 10 is provided with a timer 40 having a timer function. The timer 40 monitors a communication part 15 and resets the timer function each time when the communication part 15 communicates with a server 18 and some data is received from the server 18. When the timer function exceeds a specified time, the timer 40 determines that a failure occurs in a power line 16 (or the communication part 15), and performs the lighting process of a light-emitting part 13 at a previously set brightness.

As described above, in the remote monitoring system 1 of the foregoing embodiments or the modification example, when a failure occurs in the power line 16 (or the communication part 15), the lighting control and monitoring of the street light 10 can not be performed. However, according to the remote monitoring system 1 of the third embodiment, even when a failure occurs in the power line 16 (or the communication part 15), the lighting control and monitoring of the street light 10 can be performed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A remote monitoring system comprising:
a remote apparatus to be remotely controlled according to a specified control signal; and
a remote control apparatus to communicate with the remote apparatus by specified communication and to remotely control the remote apparatus, wherein
the remote apparatus includes
a holding part to hold location information of a location where the remote apparatus is installed,
a detection part to detect specified information, and
a communication part which associates the specified information detected by the detection part with the location information held by the holding part and transmits the associated information to the remote control apparatus.

2. The system according to claim 1, wherein the remote control apparatus maps the specified information according to the location information.

3. The system according to claim 2, wherein the remote control apparatus transmits the mapped information to an external server.

4. The system according to claim 1, wherein the remote apparatus includes an acquisition part to automatically acquire the location information of the location where the remote apparatus itself is installed, and the communication part associates the specified information with the location information acquired by the acquisition part and transmits the associated information to the remote control apparatus.

5. The system according to claim 1, wherein
the remote apparatus further includes an interface to communicate with a portable terminal by specified communication, and
when the interface communicates with the portable terminal by the specified communication, the communication part associates a notification state with the location information held by the holding part and transmits the associated notification state to the remote control apparatus.

6. The system according to claim 5, wherein when the notification state is transmitted, the remote control apparatus notifies the location information associated with the notification state to a specified notification destination.

7. The system according to claim 5, wherein the remote control apparatus maps the notification state according to the location information.

8. The system according to claim 7, wherein the remote control apparatus transmits the mapped notification state to an external server.

9. The system according to claim 1, wherein the detection part includes at least one of a temperature sensor, a humidity sensor and a weather sensor.
